(19) United States
(12) Patent Application Publication
(10) Pub. No.: US 2008/0057896 A1
(43) Pub. Date: Mar. 6, 2008

(54) Apparatus for controlling electric power of network-on-chip and method using the same

(75) Inventors: Eui Seok Kim, Yongin-si (KR); Sang Woo Rhim, Yongin-si (KR); Beom Hak Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/644,905

(22) Filed: Dec. 26, 2006

(30) Foreign Application Priority Data
Aug. 29, 2006 (KR) 10-2006-0082205

(51) Int. Cl. H04B 1/18

(52) U.S. Cl. 455/187.1

(57) ABSTRACT

Provided are an apparatus for and a method of controlling electric power of a network-on-chip (NoC). The apparatus for controlling electric power of a network-on-chip (NoC), including: a transaction monitoring unit which monitors a transaction generated from at least one of a master and a module corresponding to the master; and a clock control unit which selectively controls clock signal with respect to modules comprising the NoC, based on the monitored transaction.

### CROSS-REFERENCE TO RELATED APPLICATION

This application claims priority from Korean Patent Application No. 10-2006-0082205, filed on Aug. 29, 2006, in the Korean Intellectual Property Office, the entire disclosure of which is incorporated herein by reference.

### BACKGROUND OF THE INVENTION

1. Field of the Invention

Apparatuses and methods consistent with the present invention relate to electric power control of a network-on-chip (NoC), and more particularly, to an apparatus for and a method of controlling electric power of the NoC which control a clock signal with respect to modules comprising the NoC.

2. Description of Related Art

The convergence of a computer, communication, broadcasting, and the like has been shifting the demand for an application specific integrated circuit (ASIC) and an application specific standard product (ASSP) into the demand for a system-on-chip (SoC). Also, the SoC industry is developing, since an information technology (IT) device becomes slimmer, lighter, simpler, and more highly functional.

The SoC is a semiconductor technology of integrating all components or other electronic system into a single chip. Various technologies related to the SoC have been studied. Particularly, a method of connecting many intellectual properties (IPs) which are embedded in a chip is considered critical.

A connection method based on a bus is mainly used to connect the IPs. However, as a degree of integration of the chip becomes higher and an amount of information flow between the intellectual properties increases, the SoC using the bus structure is reaching its design limitations.

To overcome the design limitations, a network-on-chip (NoC) technology has been proposed. The NoC connects the IPs by applying a general network technology within a chip.

The NoC is a network style on-chip interconnect (OCI) to overcome the design limitation of the SoC. Through the NoC, fast, energy-efficient, and high performance of the SoC may be embodied.

In a related art, a method of controlling a clock signal of IPs connected with the bus has been proposed to embody the energy-efficient SoC. Specifically, a dynamic power dissipation may be reduced by disabling a clock signal of an IP which is not performing, from intellectual properties connected with the bus.

However, in the related art, only electric power control with respect to the intellectual properties connected with the bus is considered without considering electric power which is unnecessarily dissipated in the bus.

Accordingly, an apparatus for controlling electric power of the NoC which can reduce a dynamic power dissipation of the SoC by reducing a power consumption of the NoC is highly required.

### SUMMARY OF THE INVENTION

The present invention provides an apparatus for and a method of controlling electric power of an NoC which monitor an advanced extensible interface (AXI) transaction input to the NoC, and may selectively control clock signal with respect to modules comprising the NoC.

The present invention also provides an apparatus for and a method of controlling electric power of an NoC which monitor an NoC packet input to a router, and may selectively control clock signal with respect to modules comprising the NoC.

The present invention also provides an apparatus for and a method of controlling electric power of an NoC which activate clock signal with respect to NoC component modules when an AXI transaction occurs, disable the clock signal with respect to the NoC component modules when the AXI transaction does not occur.

The present invention also provides an apparatus for and a method of controlling electric power of an NoC which activate only clock signal of modules included in a routing path of an AXI transaction.

The present invention also provides an apparatus for and a method of controlling electric power of an NoC which activate only clock signal of modules outputting an NoC packet and receiving the NoC packet from modules included in a routing path of the NoC packet.

According to an aspect of the present invention, there is provided an apparatus for controlling electric power of a network-on-chip (NoC), including: a transaction monitoring unit which monitors a transaction generated from at least one of a master and a module corresponding to the master; and a clock control unit which selectively controls clock signal with respect to modules comprising the NoC, based on the monitored transaction.

In this instance, the clock control unit may activate the clock signal with respect to the modules when the transaction is sensed, and may disable the clock signal with respect to the modules when the transaction is not sensed.

In this instance, when the transaction is sensed, the clock control unit activates only clock signal with respect to modules included in a routing path of the sensed transaction.

According to an aspect of the present invention, there is provided an apparatus for controlling electric power of an NoC, including: a packet monitoring unit which monitors an NoC packet input to a router; and a clock control unit which selectively controls clock signal with respect to modules comprising the NoC, based on the monitored NoC packet.

In this instance, when the NoC packet is sensed, the clock control unit activates only the clock signal with respect to a module outputting the NoC packet and a module receiving the output NoC packet, from modules included in a routing path of the sensed NoC packet.

In this instance, the apparatus for controlling electric power of an NoC further comprises a transaction monitoring unit which monitors a transaction generated from at least one of a master and a module corresponding to the master, and the clock control unit which may selectively control the clock signal with respect to the modules comprising the NoC, based on the monitored transaction.

According to another aspect of the present invention, there is provided a method of controlling electric power of an NoC, including: monitoring a transaction generated from at least one of a master and a module corresponding to the master; and selectively controlling clock signal with respect to modules comprising the NoC, based on the monitored transaction.

According to still another aspect of the present invention, there is provided a method of controlling electric power of an NoC, including: monitoring an NoC packet input to a router; and selectively controlling clock signal with respect to modules comprising the NoC, based on the monitored NoC packet.

### BRIEF DESCRIPTION OF THE DRAWINGS

The above and other aspects and features of the present invention will become apparent and more readily appreciated from the following detailed description of certain exemplary embodiments of the invention, taken in conjunction with the accompanying drawings of which:

FIG. 1 is a diagram illustrating a general configuration of a NoC according to an exemplary embodiment of the present invention;

FIG. 2 is a block diagram illustrating a configuration of an apparatus for controlling electric power of an NoC according to an exemplary embodiment of the present invention;

FIG. 3 is a diagram illustrating an example of a clock control depending on whether a transaction occurs according to an exemplary embodiment of the present invention;

FIG. 4 is a diagram illustrating an example of a clock control depending on a routing path when a transaction occurs according to an exemplary embodiment of the present invention;

FIG. 5 is a block diagram illustrating a configuration of an apparatus for controlling electric power of an NoC according to another exemplary embodiment of the present invention;

FIG. 6 is a diagram illustrating an example of an operation of the apparatus for controlling electric power of an NoC according to the other exemplary embodiment of the present invention which is illustrated in FIG. 5;

FIG. 7 is a flowchart illustrating a method of controlling electric power of an NoC according to an exemplary embodiment of the present invention;

FIG. 8 is a flowchart illustrating a method of controlling electric power of an NoC according to another exemplary embodiment of the present invention;

FIG. 9 is a flowchart illustrating a method of controlling electric power of an NoC according to still another exemplary embodiment of the present invention; and

FIG. 10 is a flowchart illustrating an exemplary embodiment of operation S970 of FIG. 9.

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

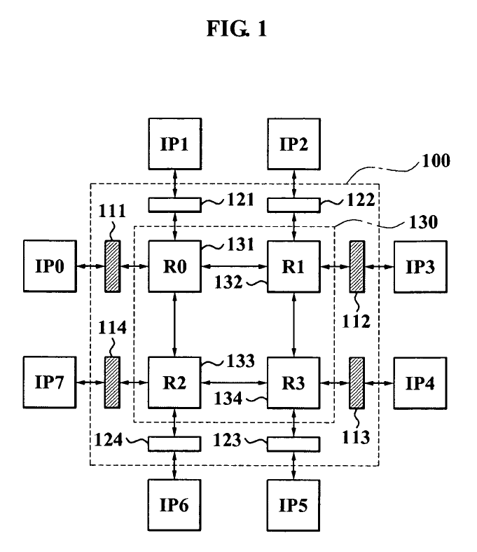

FIG. 1 is a diagram illustrating a general configuration of a network-on-chip (NoC) according to an exemplary embodiment of the present invention.

Referring to FIG. 1, the NoC 100 includes network interfaces 111, 112, 113, 114, 121, 122, 123, and 124 and a router backbone 130.

Each of the network interfaces 111, 112, 113, 114, 121, 122, 123, and 124 converts a transaction to an NoC packet, and outputs the NoC packet to a router. In this instance, the transaction is input from an intellectual property (IP), and may include an advanced microcontroller bus architecture (AMBA) high-performance bus (AHB), an open core protocol (OCP), or an AXI transaction. Also, each of the network interfaces 111, 112, 113, 114, 121, 122, 123, and 124 converts an NoC packet input from the router to the transaction, and outputs the transaction to the IP. Each of the network interfaces comprises network interfaces 111, 112, 113, and 114 (hereinafter, referred to as NIM) and network interfaces 121, 122, 123, and 124 (hereinafter, referred to as NIS). In this instance, the NIM connects a master IP and the router, and the NIS connects a slave IP and the router. Hereinafter, the transaction is described through the AXI transaction. However, the present invention is not limited to the described exemplary embodiment.

The master IP is a device actively performing such as a central processing unit (CPU). The slave IP is a device which may not actively perform, such as a memory.

The router backbone 130 includes four routers 131, 132, 133, and 134 in the exemplary embodiment of the present invention. Each of the routers 131, 132, 133, and 134 receives the NoC packet from the network interfaces 111, 112, 113, 114, 121, 122, 123, and 124, and transmits the NoC packet to another network interface or another router.

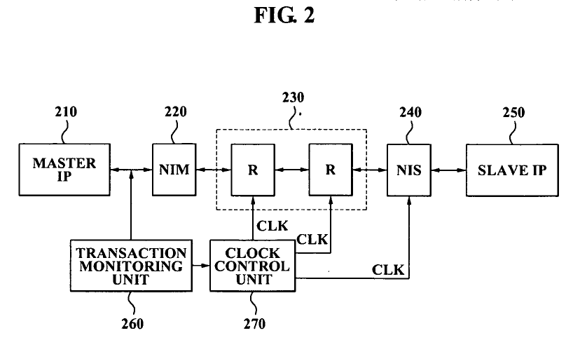

FIG. 2 is a block diagram illustrating a configuration of an apparatus for controlling electric power of an NoC according to an exemplary embodiment of the present invention.

Referring to FIG. 2, the apparatus for controlling electric power of an NoC according to an exemplary embodiment of the present invention includes a transaction monitoring unit 260 and a clock control unit 270.

The transaction monitoring unit 260 monitors an AXI transaction generated from a master IP 210 or a module corresponding to the master IP 210. Also, the transaction monitoring unit 260 outputs an activation signal with respect to the AXI transaction.

In this instance, the transaction monitoring unit 260 outputs the activation signal with respect to the AXI transaction from when a read/write AXI transaction occurs to when a response AXI transaction is received from a slave IP 250.

The clock control unit 270 selectively controls a clock CLK with respect to modules including a router R of a router backbone 230 and an NIS 240, based on the output activation signal. In this instance, the router R of the router backbone 230 and the NIS 240 comprises the NoC.

In this instance, the clock control unit 270 may activate or disable the clock signal with respect to NoC component modules. Hereinafter, the NoC component modules refer to the modules comprising the NoC. Specifically, when the transaction does not occur in the NoC, the clock control unit 270 disables the clock signal with respect to all modules excluding an NIM 220 from the NoC component modules. Accordingly, power consumption of the NoC may be reduced.

In this instance, when the transaction is sensed, the clock control unit 270 may activate only the clock signal of modules included in a routing path of the AXI transaction. Specifically, the power consumption may be reduced by disabling the clock signal with respect to modules which are not included in the routing path.

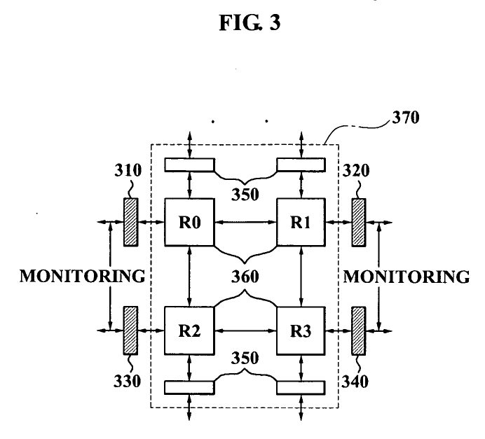

FIG. 3 is a diagram illustrating an example of clock control depending on whether a transaction occurs according to an exemplary embodiment of the present invention. FIG. 3 illustrates when a transaction monitoring unit, illustrated in FIG. 2, outputs an activation signal depending on whether an AXI transaction occurs.

Referring to FIG. 3, a transaction monitoring unit monitors between NIM 310, 320, 330 and 340 with a master IP connecting to each of the NIM 310, 320, 330 and 340. As a result of the monitoring, when a read/write AXI transaction occurs from the master IP to a slave IP, an activation signal with respect to the AXI transaction, for example, an activation signal ‘1’ is output. In this instance, a clock control unit receives the activation signal ‘1’, and activates a clock signal with respect to NoC component modules 370. Specifically, the clock control unit activates the clock signal with respect to all routers 360 and NIS 350, and operates all the NoC component modules.

Conversely, as a result of the monitoring, when the AXI transaction is completed, i.e. the AXI transaction does not occur, an activation signal with respect to the AXI transaction, for example, an activation signal ‘0’ is output. In this instance, the clock control unit receives the activation signal ‘0’, and disables the clock signal with respect to NoC component modules 370. Specifically, the clock control unit disables the clock signal with respect to all routers 360 excluding the NIM 310, 320, 330 and 340 and the NIS 350. Accordingly, the modules including all routers 360 excluding the NIM 310, 320, 330 and 340 and the NIS 350 enter a sleep mode, and power consumption may be reduced.

As described above, when a local communication which does not use the NoC is frequent, electric power which is unnecessarily consumed due to an operation of the NoC may be reduced.

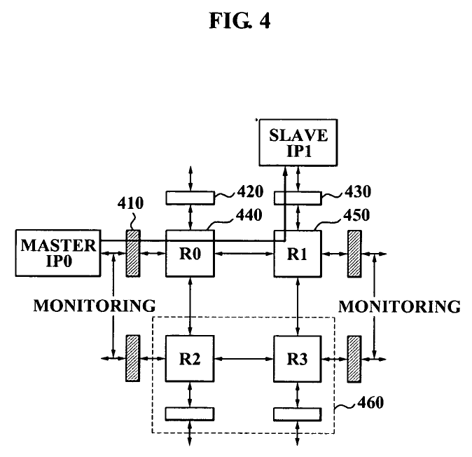

FIG. 4 is a diagram illustrating an example of a clock control depending on a routing path when a transaction occurs according to an exemplary embodiment of the present invention. FIG. 4 illustrates when the transaction monitoring unit illustrated in FIG. 2 outputs an activation signal with respect to a routing path. In this instance, it is assumed that the NoC is operated based on a static routing.

Referring to FIG. 4, the transaction monitoring unit monitors an AXI transaction. As a result of the monitoring, the AXI transaction occurs between a master IP0 and an NIM 410, the transaction monitoring unit confirms a source and a destination of a transaction from the AXI transaction, and outputs an activation signal with respect to the source and the destination. Specifically, the transaction monitoring unit verifies a routing path of the NoC from the AXI transaction and outputs the activation signal with respect to the routing path.

Table 1 illustrates an example of the activation signal according to the routing path between a source router and a destination router illustrated in FIG. 4.

TABLE 1

| | | Activation | | | Activation |
|---|---|---|---|---|---|
| Source | Destination | signal | Source | Destination | signal |
| R0 | R0 | 0001 | R1 | R0 | 0011 |
| | R1 | 0011 | | R1 | 0010 |
| | R2 | 0101 | | R2 | 1111 |
| | R3 | 1111 | | R3 | 1010 |
| R2 | R0 | 0101 | R3 | R0 | 1111 |
| | R1 | 1111 | | R1 | 1010 |
| | R2 | 0100 | | R2 | 1100 |
| | R3 | 0011 | | R3 | 1000 |

As shown in table 1, the activation signal output in the transaction monitoring unit has a length of a 4 bits. Also, each bit indicates a particular section of the routing path with respect to a router comprising the NoC. Specifically, each bit of the 4 bits sequentially corresponds to a router R3, R2, R1, and R0 from left to right. When the corresponding bit is ‘1’, a corresponding router is included in the routing path. When the bit corresponds to ‘0’, the corresponding router is not included in the routing path. As an example, when the activation signal is ‘0011’, the AXI transaction includes a router R0 440 and a router R1 450. In this instance, a length of the activation signal is not limited to the length of the 4 bits, and the length of the activation signal may vary depending on a number of the router comprising the NoC.

The activation signal according to the routing path shown in table 1 is included in the transaction monitoring unit. The source and the destination of the routing path are extracted from the AXI transaction generated in the transaction monitoring unit. Also, the activation signal with respect to the source and the destination is output.

For example, in FIG. 4, the source router is the router R0 440, and the destination router is the router R1 450. Accordingly, the activation signal which is output in the transaction monitoring unit is ‘0011’.

A clock control unit receives the activation signal ‘0011’, and activates a clock signal with respect to modules 420, 430, 440 and 450. In this instance, the modules 420, 430, 440, and 450 are associated with the router R0 440 and the router R1 450. Also, the clock control unit disables a clock signal with respect to modules 460 associated with a router R2 and a router R3. Specifically, the router R0 440 and the router R1 450 as well as NIS 420 and 430 are activated. In this instance, the NIS 420 and 430 are associated with the router R0 440 and router R1 450. When the source and the destination of the routing path are ascertained from the activation signal, the clock signal with respect to the router included in the routing path and the NIS associated with the router may be controlled respectively. As an example, in FIG. 4, the NIS associated with the router R0 440 may be disabled, since the NIS associated with the router R0 440 is not required to be operated.

Conversely, when the AXI transaction is completed, i.e. when the AXI transaction between the master IP0 and the slave IP1 is completed, the transaction monitoring unit outputs an activation signal ‘0000’. Also, the clock control unit receives the activation signal ‘0000’ and disables modules associated with the router R0 and the router R1.

In the exemplary embodiment of the present invention, only a clock signal with respect to the NoC component module included in the routing path is activated, and a clock signal with respect to remaining NoC component modules is disabled. Accordingly, an amount of electric power which is unnecessarily dissipated by an operation of the modules not included in the routing path may be reduced.

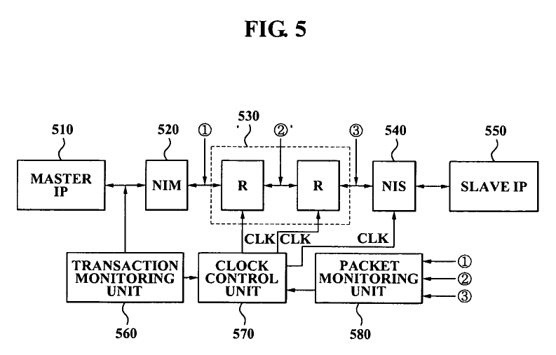

FIG. 5 is a block diagram illustrating a configuration of an apparatus for controlling electric power of an NoC according to another exemplary embodiment of the present invention.

Referring to FIG. 5, the apparatus for controlling electric power of an NoC according to another exemplary embodiment of the present invention includes a transaction monitoring unit 560, a packet monitoring unit 580, and a clock control unit 570.

The transaction monitoring unit 560 performs the same function as a transaction monitoring unit illustrated in FIG. 2. Specifically, the transaction monitoring unit 560 monitors an AXI transaction generated from a master IP 510 and/or a module corresponding to the master IP 510. Also, the transaction monitoring unit 560 outputs an activation signal with respect to the AXI transaction.

The packet monitoring unit 580 monitors NoC packets which are input from a router, and outputs an activation signal with respect to the NoC packet.

The packet monitoring unit 580 is located between an NIM 520 and the router, between the routers comprising a router backbone 530, and between an NIS 540 and the router. Also, the packet monitoring unit 580 monitors the NoC packet which are input from the NIM 520, the router, and the NIS 540.

The clock control unit 570 selectively controls a clock signal CLK with respect to modules including the router and the NIS 540, based on the activation signal output from the transaction monitoring unit 560. In this instance, the router and the NIS 540 comprise the NoC. Also, the clock control unit 570 selectively controls the clock signal CLK with respect to the modules including the router and the NIS 540, based on the activation signal output from the packet monitoring unit 580. In this instance, the clock control unit 570 may control the clock signal CLK by the activation signal output from the packet monitoring unit 580 as well as the activation signal output from the transaction monitoring unit 560, at the same time. However, it is preferable that the controlling the clock signal described above are performed sequentially.

The clock control unit 570 may activate or disable the clock signal CLK with respect to the NoC component modules. In this instance, the clock control unit 570 may activate a clock signal CLK only with respect to modules included in a routing path of the AXI transaction from the NoC component modules.

Also, the clock control unit 570 may activate only a clock signal of modules outputting the NoC packet and receiving the output NoC packet from the modules included in the routing path.

The apparatus for controlling electric power of an NoC according to another exemplary embodiment of the present invention may include only the clock control unit 570 and the packet monitoring unit 580 without the transaction monitoring unit 560.

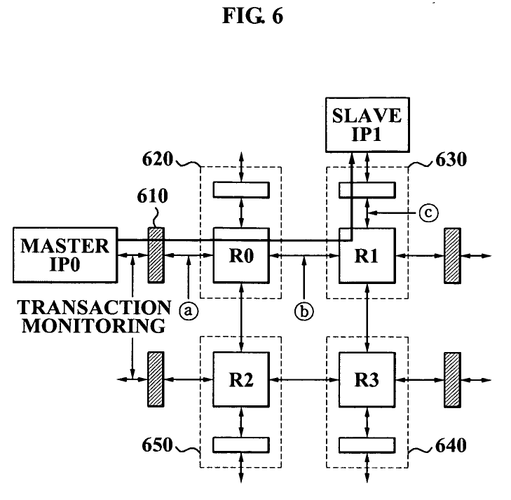

FIG. 6 is a diagram illustrating an example of an operation of the apparatus for controlling electric power of an NoC according to the other exemplary embodiment of the present invention which is illustrated in FIG. 5. FIG. 6 illustrates when an AXI transaction occurs between a master IP0 and a slave IP1. Hereinafter, the operation shown in FIG. 6 is described with the assumption that an activation signal with respect to a routing path is output in a transaction monitoring unit.

Referring to FIGS. 5 and 6, when the AXI transaction occurs in the master IP0, a transaction monitoring unit 560 outputs an activation signal with respect to a routing path, to a clock control unit 570. Specifically, the transaction monitoring unit 560 outputs an activation signal ‘0011’. In this instance, a source router of the activation signal ‘0011’ is a router R0, and a destination router of the activation signal ‘0011’ is a router R1 with reference to table 1. The clock control unit 570 receives the activation signal ‘0011’, and activates a clock signal CLK with respect to modules 620 and 630. Also, the clock control unit 570 disables a clock signal CLK with respect to modules 640 and 650. In this instance, the modules 620 and 630 are associated with the router R0 and the router R1, and the modules 640 and 650 are associated with a router R2 and a router R3.

While the clock signal CLK with respect to the modules 620 and 630 is activated, when an NoC packet converted in an NIM 610 is output, a packet monitoring unit 580 monitors an NoC packet at a point \textcircled{a}. Also, the packet monitoring unit 580 outputs an activation signal with respect to the NoC packet at the point \textcircled{a} to the clock control unit 570. As an example, when it is assumed that the NoC according to an exemplary embodiment of the present invention is operated based on a static routing and uses an XY routing method, the activation signal output from the packet monitoring unit 580 is an activation signal of ‘XY’, 2 bits. Specifically, an activation signal ‘10’ of the point \textcircled{a} is output, and the clock control unit 570 activates only a clock signal CLK of the modules 620 associated with the router R0 from the modules included in the routing path. Accordingly, only the clock signal CLK of the modules 620 associated with the router R0 is activated, and the clock signal CLK with respect to the modules 630, 640, and 650 associated with the routers R1, R2, and R3 are disabled.

When the packet monitoring unit 580 monitors an NoC packet at a point \textcircled{b}, the activation signal ‘10’ of the point \textcircled{b} is output, and the clock control unit 570 activates only the clock signal CLK with respect to the modules 630 associated with the router R1. In this instance, even when an input of the NoC packet in the point \textcircled{a} is completed, the modules 620 associated with the router R0 maintains that the clock signal CLK as activated when the NoC packet is being input to the router R1. Accordingly, when the NoC packet is monitored in the point \textcircled{b}, the clock signal CLK with respect to the modules 620 and 630 associated with the router R0 and the router R1 is activated. Also, the clock signal CLK with respect to the modules 640 and 650 associated with the router R2 and the router R3 is disabled.

When all the NoC packets at the point \textcircled{b} are input to the router R1, and the NoC packet is monitored at a point \textcircled{c}, the clock signal with respect to the modules 620 associated with the router R0 is disabled. Also, only the clock signal CLK of the modules 630 associated with the router R1 is maintained to be activated. Specifically, only the clock signal CLK of the modules 630 associated with the router R1 is activated. Also, the clock signal CLK with respect to modules 620, 640 and 650 associated with the router R0, the router R2, and the router R3 are disabled.

As described above, a clock control process by the NoC packets of points \textcircled{a}, \textcircled{b}, and \textcircled{c} is identically performed in a process of transmitting an NoC packet with respect to a response from the slave IP1 to the master IP0. Specifically, the clock control process by the NoC packet of the points \textcircled{c}, \textcircled{b}, and \textcircled{a} is performed in reverse order.

Also, when the transaction monitoring unit 560 monitors the AXI transaction with respect to the response, the clock signal CLK with respect to the NoC component modules included in the routing path is disabled.

As described above, the apparatus for controlling electric power of an NoC according to another exemplary embodiment of the present invention, illustrated in FIG. 5 may add a clock control function by the NoC packet to a clock control function by the AXI transaction, and thereby may reduce power consumption. Also, the apparatus for controlling electric power of an NoC according to another exemplary embodiment of the present invention may include only the clock control function by the NoC packet.

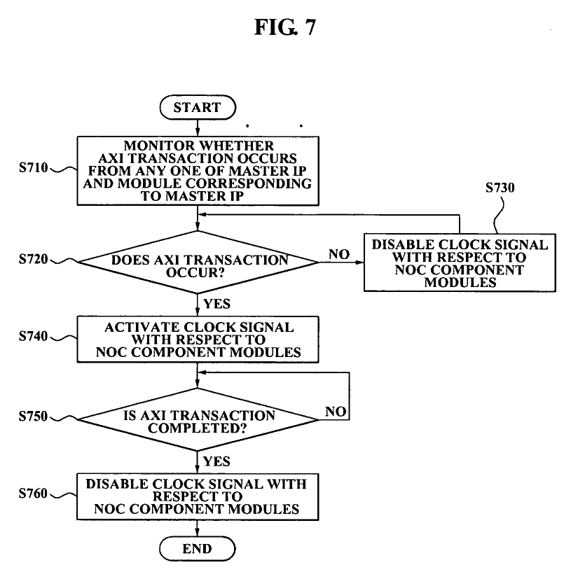

FIG. 7 is a flowchart illustrating a method of controlling electric power of an NoC according to an exemplary embodiment of the present invention. In this instance, monitoring whether an AXI transaction occurs, and activating a clock signal with respect to NoC component modules only when the AXI transaction occurs are included.

Referring to FIG. 7, in operation S710, whether the AXI transaction occurs from the master IP or a module corresponding to the master IP is monitored.

In operation S720, a result of the monitoring is determined. When the AXI transaction does not occur, a clock signal of the NoC component modules is disabled in operation S730.

Conversely, when the AXI transaction occurs, the clock signal with respect to the NoC component modules, i.e. a router backbone and an NI, is activated in operation S740.

When the AXI transaction is completed, in operation S750, the clock signal with respect to the NoC component modules is disabled in operation S760. Accordingly, power consumption may be reduced.

Specifically, the method of controlling electric power of an NoC illustrated in FIG. 7 activates or disables the clock signal with respect to the NoC component modules depending on whether the AXI transaction occurs, and thereby may reduce the power consumption on a local communication which does not use the NoC.

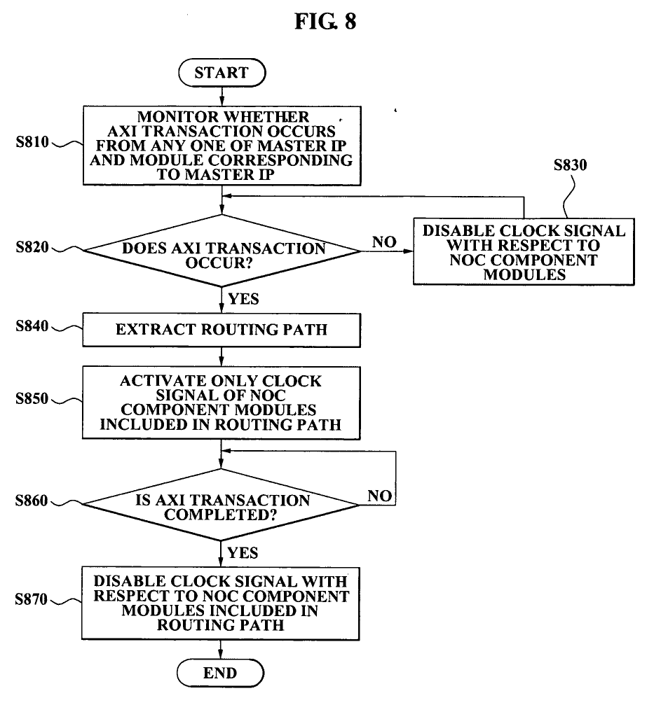

FIG. 8 is a flowchart illustrating a method of controlling electric power of an NoC according to another exemplary embodiment of the present invention. In this instance, monitoring whether an AXI transaction occurs, and activating only a clock signal of NoC component modules included in a routing path of the AXI transaction when the AXI transaction occurs are included.

Referring to FIG. 8, in operation S810, whether the AXI transaction occurs from the master IP or a module corresponding to the master IP is monitored.

In operation S820, a result of the monitoring is determined. When the AXI transaction does not occur, a clock signal with respect to the NoC component modules is disabled in operation S830.

Conversely, when the AXI transaction occurs, the routing path is extracted from the AXI transaction in operation S840. In this instance, the routing path may be ascertained by a source and a destination of the AXI transaction. As an example, when the NoC is operated based on a static routing, the routing path according to the source and the destination of the AXI transaction may be previously set. The routing path according to the source and the destination of the AXI transaction may be composed of a look-up table.

According to the extracted routing path, only the clock signal of the NoC component modules included in the routing path is activated in operation S850. Specifically, the clock signal with respect to the NoC component modules which are not included in the routing path is disabled.

When the AXI transaction is completed, in operation S860, the clock signal with respect to the NoC component modules included in the routing path is disabled in operation S870. Specifically, when a response AXI transaction of the AXI transaction generated in the master IP is received, the clock signal with respect to the NoC component modules is disabled. Accordingly, power consumption which is dissipated by the NoC may be reduced.

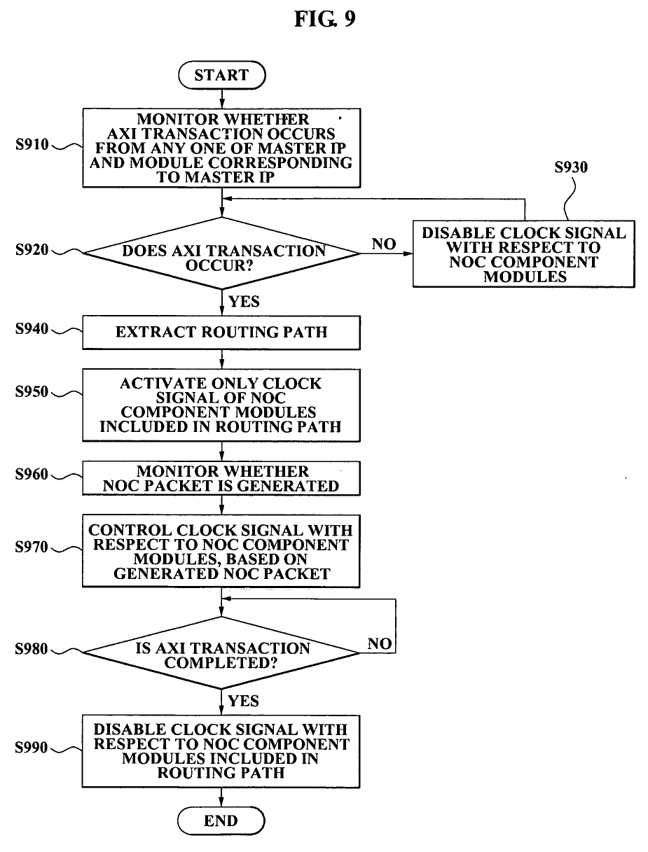

FIG. 9 is a flowchart illustrating a method of controlling electric power of an NoC according to still another exemplary embodiment of the present invention. In this instance, monitoring whether an AXI transaction occurs, activating only a clock signal of NoC component modules included in a routing path when the AXI transaction occurs, monitoring whether an NoC packet is generated, and selectively controlling a clock signal with respect to the NoC component modules based on the NoC packet when the NoC packet is generated are included.

The method of controlling electric power of an NoC according to the current exemplary embodiment of the present invention, shown in FIG. 9, includes a method of controlling electric power of an NoC according to the other exemplary embodiment of the present invention, shown in FIG. 8, and a function of controlling the clock signal with respect to the NoC component modules based on an NoC packet monitoring. A clock control function with respect to the NoC component modules by an AXI transaction monitoring and a clock control function with respect to the NoC component modules by the NoC packet monitoring may be applied together. However, the method of controlling electric power of an NoC according to the current exemplary embodiment of the present invention may include only the clock control function with respect to the NoC component modules by the NoC packet monitoring.

Referring to FIG. 9, operations of S910 through S950 are identical to operations of S810 through S850 of FIG. 8. Specifically, in operation S910, whether the AXI transaction occurs from the master IP or a module corresponding to the master IP is monitored.

In operation S920, a result of the monitoring is determined. When the AXI transaction does not occur, the clock signal with respect to the NoC component modules is disabled in operation S930.

Conversely, when the AXI transaction occurs, the routing path is extracted from the AXI transaction in operation S940.

According to the extracted routing path, only a clock signal of the NoC component modules included in the routing path is activated in operation S950.

A converted NoC packet of the AXI transaction is monitored. Specifically, whether the NoC packet is generated in operation S960 is monitored. In this instance, the monitoring is performed between the NoC component modules where the NoC packet is input, for example, between an NIM and a router, between routers, and between the router and an NIS.

In operation S970, the clock signal with respect to the NoC component modules is controlled based on the generated NoC packet.

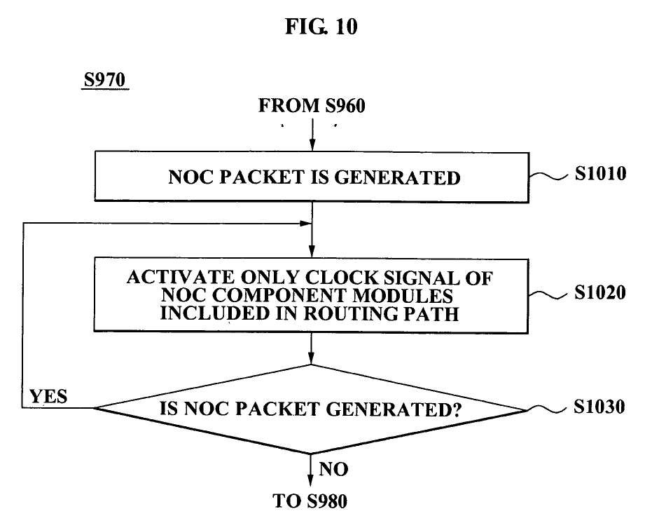

With reference to FIG. 10, the operation S970 will be described in detail.

FIG. 10 is a flowchart illustrating an exemplary embodiment of operation S970 of FIG. 9.

Referring to FIG. 10, in controlling the clock signal with respect to the NoC component modules, when the NoC packet is generated in operation S1010, a clock signal with respect to a module to receive the generated NoC packet is activated. In this instance, when all NoC packets are output from modules receiving the NoC packets to modules included in a subsequent routing path, the clock signal with respect to the NoC component modules which receive the NoC packets as well as output the NoC packets is activated in operation S1020. Specifically, when the NoC packet moves according to the routing path, only the clock signal of the NoC component modules which receive the NoC packet and output the NoC packet, from the NoC component modules included in the routing path, is activated. Accordingly, power consumption may be reduced. When many routers exist, the power consumption may be effectively reduced.

Operations described above are repeated until the NoC packet is not generated. Specifically, whether the NoC packet is generated in operation S1030 is determined. When the NoC packet is generated, S1020 is performed again, and when the generated (or monitored) NoC packet does not exist, operation S980 shown in FIG. 9 is performed.

Referring again to FIG. 9, when the clock control function with respect to the NoC component modules by the NoC packet monitoring is completed, whether the AXI transaction is completed in operation S980 is determined.

When the AXI transaction is completed, i.e. a response AXI transaction to the AXI transaction is received from the slave IP, the clock signal with respect to the NoC component modules included in the routing path is disabled in S990.

Through operations described above, the power consumption may be reduced.

The above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to exemplary embodiments of the present invention, an apparatus for and a method of controlling electric power of an NoC which monitor an AXI transaction input to the NoC, selectively control a clock signal with respect to NoC component modules, and thereby may reduce a power consumption of the NoC.

Also, according to exemplary embodiments of the present invention, an apparatus for and a method of controlling electric power of an NoC which monitor an NoC packet input to a router, selectively control a clock signal with respect to NoC component modules based on the monitored NoC packet, and thereby may reduce a power consumption of the NoC.

Also, according to exemplary embodiments of the present invention, an apparatus for and a method of controlling electric power of an NoC which activate a clock signal with respect to NoC component modules when an AXI transaction occurs, disable the clock signal with respect to the NoC component modules when the AXI transaction does not occur, and thereby may reduce an amount of electric power unnecessarily dissipated in the NoC.

Also, according to exemplary embodiments of the present invention, an apparatus for and a method of controlling electric power of an NoC which activate only a clock signal of modules included in a routing path of an AXI transaction, and thereby may reduce a power consumption of the NoC.

Also, according to exemplary embodiments of the present invention, an apparatus for and a method of controlling electric power of an NoC which activate only a clock signal of modules outputting an NoC packet and receiving the NoC packet from modules included in a routing path of the NoC packet, and thereby may reduce power consumption of the NoC.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for controlling electric power of a network-on-chip (NoC), comprising:
a transaction monitoring unit which monitors a transaction generated from at least one of a master and a module corresponding to the master; and
a clock control unit which selectively controls clock signal with respect to modules comprising the NoC, based on the monitored transaction.

2. The apparatus of claim 1, wherein the clock control unit activates the clock signal with respect to the modules when the transaction is sensed, and disables the clock signal with respect to the modules when the transaction is not sensed.

3. The apparatus of claim 1, wherein the clock control unit, when the transaction is sensed, activates only clock signal with respect to modules included in a routing path of the sensed transaction.

4. The apparatus of claim 1, wherein the NoC is operated based on a static routing.

5. The apparatus of claim 1, wherein the transaction corresponds to an advanced extensible interface (AXI) transaction.

6. An apparatus for controlling electric power of a network-on-chip (NoC), comprising:
a packet monitoring unit which monitors an NoC packet input to a router; and
a clock control unit which selectively controls clock signal with respect to modules comprising the NoC, based on the monitored NoC packet.

7. The apparatus of claim 6, wherein the clock control unit, when the NoC packet is sensed, activates only clock signal with respect to a module outputting the NoC packet and a module receiving the output NoC packet, from modules included in a routing path of the sensed NoC packet.

8. The apparatus of claim 6, further comprising:
a transaction monitoring unit which monitors a transaction generated from at least one of a master and a module corresponding to the master, and
wherein the clock control unit selectively controls the clock signal with respect to the modules comprising the NoC, based on the monitored transaction.

9. The apparatus of claim 6, wherein the NoC is operated based on a static routing.

10. A method of controlling electric power of a network-on-chip (NoC), comprising:
monitoring a transaction generated from at least one of a master and a module corresponding to the master; and
selectively controlling clock signal with respect to modules comprising the NoC, based on the monitored transaction.

11. The method of claim 10, wherein the controlling activates the clock signal with respect to the modules when the transaction is sensed, and disables the clock signal with respect to the modules when the transaction is not sensed.

12. The method of claim 10, wherein the controlling, when the transaction is sensed, activates only clock signal with respect to modules included in a routing path of the sensed transaction.

13. The method of claim 10, wherein the NoC is operated based on a static routing.

14. The method of claim 10, wherein the transaction corresponds to an advanced extensible interface (AXI) transaction.

15. A method of controlling electric power of a network-on-chip (NoC), comprising:
monitoring an NoC packet input to a router; and
selectively controlling clock signal with respect to modules comprising the NoC, based on the monitored NoC packet.

16. The method of claim 15, wherein the controlling, when the NoC packet is sensed, activates only clock signal with respect to a module outputting the NoC packet and a module receiving the output NoC packet, from modules included in a routing path of the sensed NoC packet.

17. The method of claim 15, further comprising:
monitoring a transaction generated from at least one of a master and a module corresponding to the master; and
selectively controlling the clock signal with respect to the modules comprising the NoC, based on the monitored transaction, and wherein the monitoring of the transaction and the controlling of the clock signal according to the monitored transaction are performed prior to monitoring the NoC packet input to the router.

18. The method of claim 15, wherein the NoC is operated based on a static routing.

19. A computer-readable recording medium storing a program for implementing a method of controlling electric power of a network-on-chip (NoC), comprising:
monitoring an NoC packet input to a router; and
selectively controlling clock signal with respect to modules comprising the NoC, based on the monitored NoC packet.
